(19) United States
(12) Patent Application Publication
(10) Pub. No.: US 2012/0095760 A1
(43) Pub. Date: Apr. 19, 2012

(54) APPARATUS, A METHOD AND A COMPUTER PROGRAM FOR CODING

(76) Inventor: Pasi S. Ojala, Kirkkonummi (FI)

(21) Appl. No.: 13/140,647

(22) PCT Filed: Dec. 19, 2008
(86) PCT No.: PCT/FI08/50777

§ 371 Date: Jan. 6, 2012

(51) Int. Cl. G10L 21/02

(52) U.S. Cl. 704/228; 704/226; 704/E19.001

(57) ABSTRACT

Various embodiments of the invention provide scalable and distributed input signal coding activity detection and coding thereof (e.g. VAD/DTX) processing framework. An apparatus comprising an encoder is shown. The apparatus can be a terminal, for example a mobile phone, computer or the like. The apparatus may act as transmitter etc.

The apparatus is coupled with a network element (alternatively referred to as an intermediate element or the like). The network element is coupled with apparatuses. The apparatuses can also be terminal devices such as mobile phone, computer or the like. The apparatuses may act as receivers etc. The apparatus comprises a detector configured to detect whether an input signal is active input signal or non-active input signal. There are various different detectors such as the VAD or SAD referred to above. The apparatus comprises also an encoder configured to encode a background noise component of the input signal and a signal component of said active input signal as at least two separate protocol layers during a period of said active input signal. Furthermore the apparatuses may contain the encoder and the detector as well. Also the network element may in some cases have the detector and the encoder. The network element comprises a detector configured to detect a network or network terminal receiver characteristics. The network element comprises an encoder configured to forward said input signal on a basis of said network or network terminal receiver characteristics so that depending on the network or network terminal receiver characteristics said in-put signal is encoded to meet the network or network terminal receiver characteristics.

### TECHNICAL FIELD

The invention concerns an apparatus, method, and a computer program for coding a signal.

### BACKGROUND

One of the current challenges in packet switched (PS) voice services—for example Voice over IP (VoIP)—run over wireless networks, e.g. cellular ones, is to provide good voice quality at high enough spectrum efficiency. When considering a PS telephone or conferencing service, an obvious reference both in terms of voice quality and efficient usage of radio link resources is the existing circuit switched (CS) cellular telephony service such as GSM. For example in 3rd generation networks being specified within the 3rd Generation Partnership Project (3GPP) the applied speech codecs are generally the same in both PS and CS voice services. This quite obviously provides a challenge in terms of bandwidth required per user due to protocols employed for PS operation, for example the combination of Real-time Transport Protocol (RTP), User Datagram Protocol (UDP), and Internet Protocol (IP). Thus, while IP based PS operation can be expected to provide benefits for example in terms of flexibility for the mobile network operators, it may need special attention to become a competitive alternative with equal quality of service for the corresponding CS service. The evolution of 3GPP radio technologies to Evolved Packet System (EPS), the combination of Long Term Evolution (LTE) of radio access and Service Architecture Evolution (SAE), will introduce new challenges and possibilities for speech and audio coding regarding the functionality, applicability, available transmission channel bit rate, and expected Quality of Experience (QoE).

Characteristics of the codec employed in a voice/audio communication system, such as speech and audio codec or the like, is a major component affecting the overall system capacity and QoE. Typically, higher encoding bit-rate implies higher quality—higher QoE, which on the other hand typically implies reduced overall system capacity. One of the known technologies applied in order to increase the system capacity with a minor impact on the QoE is to exploit the characteristics of the input signal by identifying the periods of input signal comprising meaningful content and selecting only these periods for encoding and transmission over a network. As an example, a speech signal typically consists of alternating periods of active speech and silence: there are silent periods between utterances, between words, and sometimes even within words. Furthermore, in a conversation the alteration of speech and silent periods is further emphasized, since typically only one person at a time is speaking—i.e. providing utterances comprising periods of active speech.

A speech/audio encoding system—typically processing an audio input signal as short segments called frames, usually having a temporal length in a range from 2 to 100 ms—may employ a Voice Activity Detector (VAD) to classify each input frame either as active (speech) signal or as inactive (non-speech) signal. Typically also other types of meaningful signals, such as information tones like Dual-Tone Multi-Frequency (DTMF) tones and in particular music signals are content that are classified as active signal. Plain background noise, on the other hand, is usually classified as inactive signal. Since the aim of the VAD functionality is to distinguish all types of active signal content from the inactive one, a term Signal Activity Detector (SAD) is recently also used to describe the nature of this functionality.

A VAD or SAD may be used to control a Discontinuous Transmission (DTX) functionality—also known as silence compression or silence suppression—aiming to select for transmission only those frames that are required for desired quality. A DTX functionality may operate in such a way that only frames classified as active signal are provided for transmission. As a result, only the frames representing active signal will be available in the receiving end, and no information regarding the input signal during inactive periods is received. However, even during the inactive periods some level of background noise is typically present in the audio input, and providing an estimation of this noise may provide improved QoE. Therefore, instead of dismissing the signal content in frames representing the periods of inactive input signal, parameters approximating the characteristics of the background noise may be provided—typically at reduced bit-rate—to enable Comfort Noise Generation (CNG) in the receiving end. The frames used to carry the parameters describing the characteristics of the background noise are commonly called silence descriptor (SID) frames.

As an example, a SID frame may carry information on the spectral characteristics and the energy level of current background noise. Such a known technology is presented for example in 3GPP Technical Specification 26.192, “Adaptive Multi-Rate (AMR-WB) speech codec; Comfort noise aspects”, which discloses computation of a set of Linear Predictive Coding (LPC) filter coefficients and a gain parameter determining the signal energy level to included in a SID frame.

As an example of the DTX functionality, a SID frame may be encoded and/or provided for transmission according to a pre-defined pattern, for example at suitably selected intervals. As another example, encoding and/or providing a SID frame for transmission may be based on the characteristics of the background noise: for example a SID frame may be encoded and/or provided for transmission in case a change in the background noise characteristics exceeding a pre-defined threshold is encountered. As a further example, background noise characteristics may be used to control the interval at which the SID frames are encoded and/or provided for transmission.

Another known example of a SID is disclosed on a PCT patent application WO2008/100385, discussing the scalability of comfort noise. The basic idea of WO 2008/100385 is to enable a bandwidth extension layer on top of a SID frame carrying the narrowband comfort noise parameters in order to provide wideband comfort noise. Furthermore, a layered structure for a SID frame is proposed, providing a base layer and an enhancement layer for improved quality comfort noise better matching the properties of the actual background noise signal at the encoder input. Thus, an encoder/transmitter operating according to WO 2008/100385 encodes/transmits the background noise information using the layered structure, however only during inactive input signal. During active input signal background noise information layer is not applied at all.

Yet another known example of a SID is disclosed on a European patent EP1768106, which discusses embedding the comfort noise parameters within a normally encoded speech frame. The basic idea of EP1768106 is to include the parameters of a SID frame in the perceptually least significant bits of a normally encoded speech frame, thereby providing both normally encoded frame and SID frame corresponding to the same input frame without affecting the frame size (i.e. bit-rate).

Although typically employing a SAD/DTX/CNG in a known system implies reduced subjective QoE during inactive periods, it may at the same time introduce a significant capacity and battery life time improvement. However, a limitation of the SAD/DTX/CNG functionality described above is that it does not, nevertheless, fully support different use cases and does not take into account the heterogeneous nature of the network and receiving devices with different capabilities—possibly also connected to the network through access networks with different characteristics. For example in a multi-party conference the participants may be connected through different access links having different requirements and facilitating different use cases. Some receiving devices or access networks may have special requirements for example not to employ DTX in downlink direction to ensure maximum perceived quality—also for speech but especially for music signals, while some receiving devices are connected through capacity constrained access links benefitting—or even requiring—the usage of DTX functionality. Thus, for example in a PS scenario or in a Tandem Free Operation (TFO) or Transcoder Free Operation (TrFO) scenario where the sending terminal controls the DTX operation there is no efficient way for an intermediate element, such as a conference unit of a multi-party conference session to allow different mode of operation for certain receiving devices. Another limitation is that in a scenario where the sending device controls the DTX functionality there is no possibility for an intermediate network element—e.g. a gateway on the border of a bandwidth-limited access network—to affect the applied DTX scheme without significant further processing.

### SUMMARY

It is the object of the invention to provide more versatility for coding in various situations.

In accordance with an aspect of the invention there is provided an apparatus, comprising

a detector configured to extract detection information indicating whether an input signal is active input signal or non-active input signal, and

an encoder configured to encode the input signal as one or more encoded components representative of a background noise component of said input signal within a period and as one or more encoded components representative of an active signal component of said input signal within said period.

In accordance with another aspect of the invention there is provided an apparatus, comprising

a receiver configured to receive encoded input signal comprising detection information whether an input signal is active input signal or non-active input signal,

a detector configured to detect a network or a receiving terminal device characteristics,

an encoder configured to encode an output signal based at least part on said encoded input signal and said network or receiving terminal device characteristics so that, depending on the network or receiving terminal device characteristics, said output signal is encoded to meet the network or receiving terminal device characteristics.

In accordance with yet another aspect of the invention there is provided a method, comprising

extracting detection information indicating whether an input signal is active input signal or non-active input signal, and

encoding the input signal as one or more encoded components representative of a background noise component of said input signal within a period and as one or more encoded components representative of an active signal component of said input signal within said period.

In accordance with another aspect of the invention there is provided a method, comprising

receiving encoded input signal comprising detection information whether an input signal is active input signal or non-active input signal,

detecting a network or a receiving terminal device characteristics,

encoding an output signal based at least part on said encoded input signal and said network or receiving terminal device characteristics so that, depending on the network or receiving terminal device characteristics, said output signal is encoded to meet the network or receiving terminal device characteristics.

In accordance with another aspect of the invention there is provided a computer program, comprising code configured to perform the methods when run on a processor.

Some further embodiments of the invention allow improved flexibility for a system employing audio or video coding. Another further embodiment improves the overall perceived quality in for example conferencing scenarios, wherein some of the participants are behind capacity restricted network segments or access links or using terminal devices with restricted capabilities. The system of the further embodiment can provide more optimized perceived quality for the non-restricted participants.

### BRIEF DESCRIPTION OF THE DRAWINGS

Various further embodiments of the invention will now be described, by way of demonstration purposes only, with reference to the accompanying drawings, in which:

FIG. 1 depicts a multiparty coding session in accordance with an embodiment of the invention,

FIG. 2 depicts an apparatus for coding in which principles of the inventions can be applied in accordance with various embodiments of the invention,

FIG. 3 depicts an apparatus for intermediate coding which can operate in accordance with various embodiments of the invention,

FIG. 4 depicts a method for coding according to various embodiments of the invention,

FIG. 5 depicts a method for coding according to various embodiments of the invention,

FIG. 6 depicts another example of a multiparty coding session in accordance with an embodiment of the invention,

FIG. 7 depicts a multiparty coding session more depicting scalable packets in accordance with an embodiment of the invention.

### DESCRIPTION OF FURTHER EMBODIMENTS

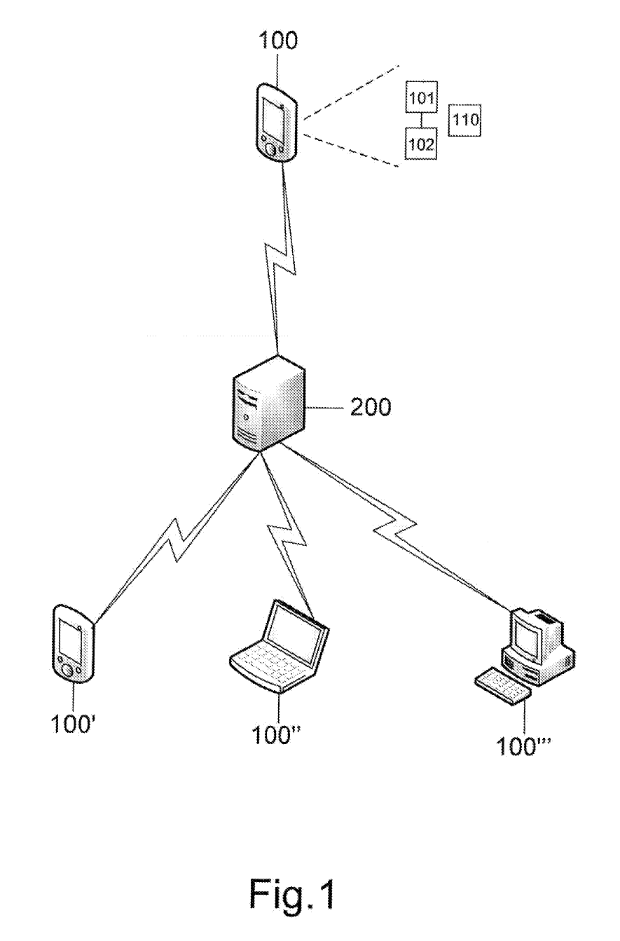

Various embodiments of the invention provide scalable and distributed DTX processing framework. FIG. 1 depicts a multiparty audio and/or voice coding session in accordance with an embodiment of the invention. An apparatus 100 comprising an encoder 102 is shown. The apparatus 100 can be a terminal device, for example a mobile phone, computer or the like. The apparatus 100 may comprise a transmitter 110 or the like. The apparatus 100 is coupled with a network element 200 (alternatively referred to as an intermediate element or the like). The network element 200 is coupled with apparatuses 100′, 100″, 100′″. The apparatuses 100′, 100″ and 100′″ can also be terminal devices such as mobile phone, computer or the like. The apparatuses 100′, 100″, and 100′″ may comprise receivers etc. The apparatus 100 comprises a detector 101 configured to detect input signal characteristics, for example whether an input signal is active input signal or non-active input signal. There are various different detectors such as the VAD or SAD referred to above. The apparatus 100 comprises also an encoder 102 configured to encode the input signal. The apparatus 100 may be configured to encode a background noise component of the input signal and an active signal component of said active input signal as at least two separate encoded components. Furthermore the apparatuses 100′, 100″ and 100′″ may comprise the encoder 102 and the detector 101 as well. Also the network element 200 may in some cases comprise the detector 101 and the encoder 102.

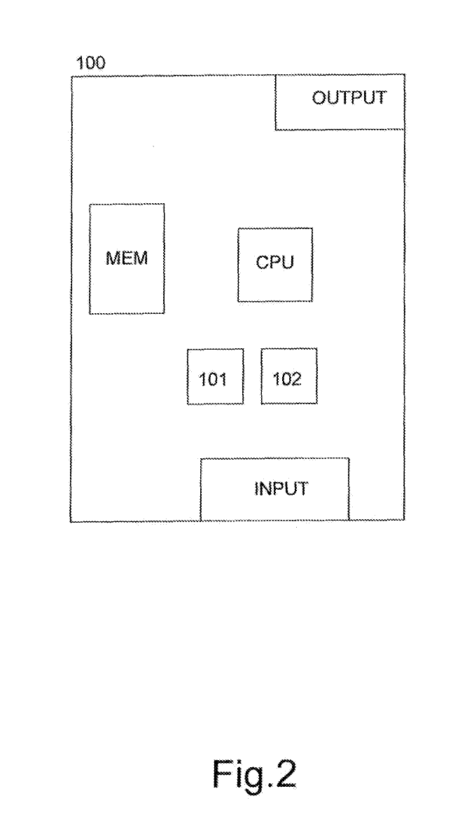

FIG. 2 depicts an apparatus 100 configured for coding. The apparatus comprises the detector 101 and the encoder 102. Input, output, a CPU and a storage MEM are also shown. In an embodiment the output comprises a transmitter 110. The apparatus may comprise programmable hardware or software or middleware to implement the operations and functionalities of the encoder 102 and the detector 101.

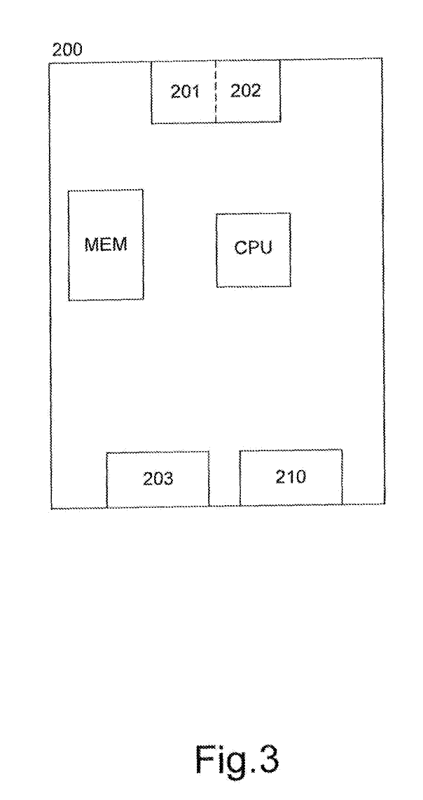

FIG. 3 depicts a network element 200 in accordance with an embodiment of the invention. The network element 200 comprises a receiver 201 configured to receive input signal, e.g. from a network terminal transmitter, such as apparatus 100, or from another network element (not shown). The received input signal comprising active input signal, non-active input signal, and detection information which part of the signal establishes the active input signal and non-active input signal. The network element 200 comprises a detector 201 configured to detect a network or a receiving terminal device characteristics. The network element 200 comprises an encoder 203 configured to process and provide for transmission said input signal at least partially based on said detection information and/or said network or receiving terminal device, (e.g. the receiver apparatus 100′,100″,100′″) characteristics so that depending on the network or receiving terminal device characteristics said input signal is encoded to meet the network or receiving terminal device characteristics. The network element further comprises a transmitter 210 configured to transmit received, and possibly processed, input signal to one or more another network elements (not shown) or to one or more receiving terminal devices (e.g. 100′,100″,100′″). The network element 200 may comprise programmable hardware or software or middleware to implement the operations and modules of the receiver 201, the detector 202, and the encoder 203. Examples of the network element 200 can be a conference unit/server, an intermediate transcoding element in the network, a media gateway, etc.

In various embodiments of the invention the computer program can be a piece of a code or computer program product. The product is an example of a tangible object. For example, it can be a medium such as a disc, a hard disk, an optical medium, CD-ROM, floppy disk, or the like storage etc. In another example the product may be in a form of a signal such as an electromagnetic signal. The signal can be transmitted within the network for example. The product comprises computer program code or code means arranged to perform the operations of various embodiments of the invention. Furthermore the invention can be embodied on a chipset or the like.

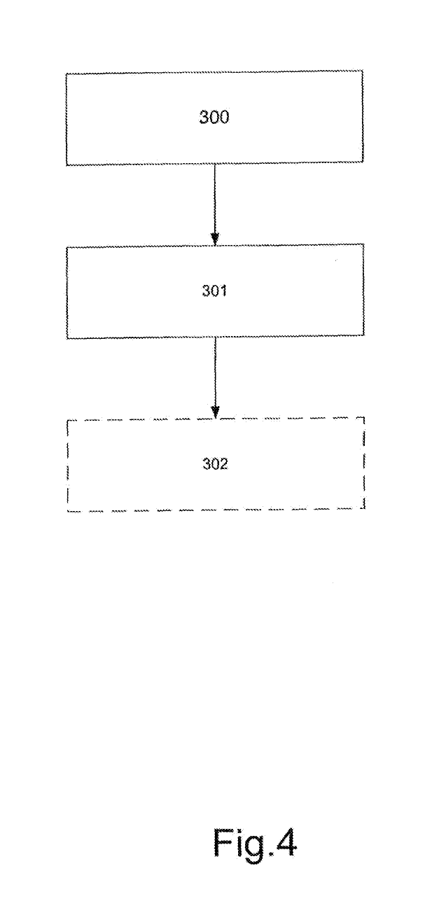

FIG. 4 depicts a method for coding according to various embodiments of the invention. The method comprises detecting (300) whether an input signal is active input signal or non-active input signal. Furthermore the method comprises encoding (301) the input signal. The encoding may comprise encoding to provide one or more encoded components representative of a background noise component of the input signal and one or more encoded components representative of an active signal component of said active input signal.

In a further embodiment, the method further comprises outputting (302) one or more encoded components representative of a background noise component of the input signal and one or more encoded components representative of an active signal component of said input signal.

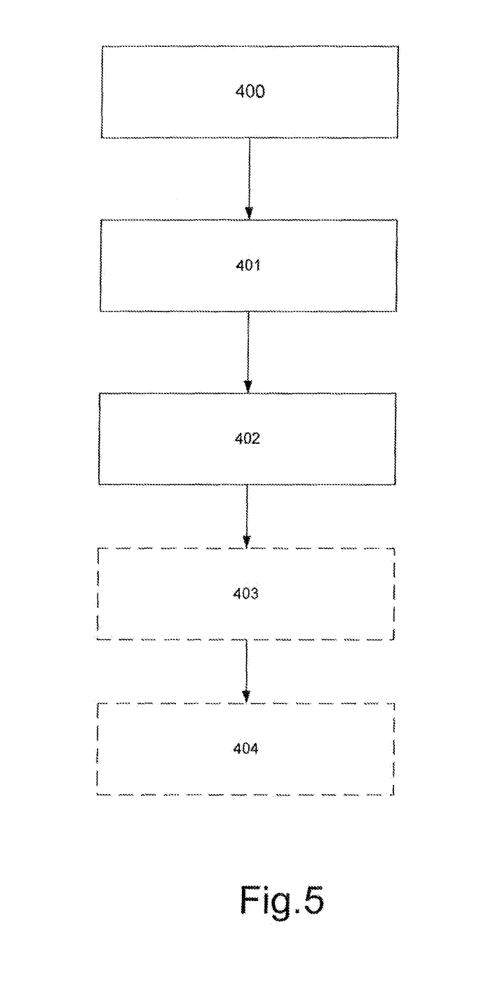

FIG. 5 depicts a method for coding in accordance with various embodiments of the invention. The method comprises receiving (400) an input signal from a terminal device transmitter or from a network element transmitter, the input signal comprising active input signal, non-active input signal, and detection information which part of the signal establishes the active input signal and non-active input signal. The method furthermore comprises detecting (401) a network or receiving terminal device characteristics. Yet furthermore the method comprises processing and providing for transmission (402) said input signal at least partially based on said detection information and/or said network or receiving terminal device characteristics so that depending on the network or receiving terminal device characteristics, said input signal is encoded to meet the network or receiving terminal device characteristics.

In a further embodiment of the invention said input signal may be processed and provided for transmission (403) into a downlink direction to the network or to a receiving terminal device. Furthermore, the possibly processed forwarded input signal establishes (404) a bit stream so that the bit stream is configured to be scaled to meet a required bit stream according to the detection information and the detector.

### Scalability of Network Element Coding in Downlink

Referring now to various further embodiments, in an embodiment a detector 101, for example a VAD, is run at the transmitting terminal device to extract detector information for each input frame, for example at the apparatus 100. The detector 101 may be included as part of the encoder 102, or it may be included as part of another processing block (not shown) with a connection to the encoder 102, or it may be included as a separate dedicated processing block (not shown) with a connection to the encoder 102. All input frames are encoded, by the encoder 102 or the like, as if the input frames were representing active content. The detector information such as VAD information is provided together with the respective encoded components for the receiving device 100′,100″,100′″ or for an intermediate element 200 (such as conference server or the like).

Thus in the embodiment of the invention there is being taken into account the layered nature of current and evolving speech codecs such as the one specified in ITU-T Recommendation G.718 in the DTX processing. Instead of having the DTX functionality and SID frame determination as described above as in the known speech/audio coding techniques in the transmitting terminal device and thus limiting the possibilities for a network element to control the quality of experience at the receiving terminal device, the encoder 102 may provide only the detection information like SAD/VAD information, as part of the encoded bit stream. The detection information can for example be a two-valued VAD flag in a further embodiment. In other embodiments the detection information may comprise one or more distinct indicators having suitably selected range of possible values. The network element 200, such as conference server, receiving the speech/audio frames and forwarding them, possibly after applying suitable processing, to the receiving terminal device 100′, to multiple receiving terminal devices 100′,100″,100′″, to another network element, or to multiple network elements (not shown), may apply suitable DTX processing in downlink direction if the usage of DTX functionality is desired by the receiving terminal device 100′,100″,100′″. Alternatively, the network element 200 may apply suitable DTX processing if it is requested by the network. Furthermore, there can be other indicators calling for the usage of DTX.

### Coding of Input Signal

In various embodiments of the invention a related coding technique aiming to take into account the properties of a heterogeneous network—especially the local bandwidth limitations for example in access networks—and different capabilities of the receiving terminal devices is so called layered coding—in some contexts also referred to e.g. as scalable or embedded coding). The basic idea is to encode the input signal as several layers: a core layer (also known as a base layer), and possibly one or more enhancement layers. While having access only to the core layer is sufficient for successful decoding, the one or more enhancement layers may be used to provide improvement for the decoded quality. An example of a layered codec is described in ITU-T Recommendation G.718. One of the benefits of layered encoding approach is that a media aware network element may be able to adjust the bandwidth of the encoded signal by removing one or more enhancement layers if for example changing transmission conditions or different access link bandwidths in a multi-party session require such limitation.

In an embodiment each frame of the input signal may be encoded and provided for transmission or storage as a single component comprising the background noise component and the active signal component of the input signal. Furthermore, respective detection information, such as the VAD information as described above is provided together with the encoded signal. Alternatively, the input signal may be encoded and provided for transmission according to the layered coding technique as described above, each encoded layer/component representing the background noise component of the input signal and the active signal component of the input signal.

Another embodiment of the invention introduces one or more encoded components representative of the background noise component of the input signal or the like to the encoded bit stream. The encoded component(s) representative of the background noise component may be provided together with the active signal component encoded by a codec, for example the one specified in 3GPP Technical Specification 26.090 (AMR) or 3GPP Technical Specification 26.190 (AMR-WB) processing the input signal into a single encoded component. It should be noted that the encoded bit stream of a conventional (non-layered) codec can be considered to constitute a base layer of a layered codec—i.e. the layer that is required for successful decoding. Alternatively, in a further embodiment the active signal component may be encoded by a layered codec such as the above-mentioned ITU-T G.718 comprising a base layer (also known as a core layer) and possibly a number of enhancement layers. Furthermore, in yet another embodiment the active signal component may be encoded by any suitable current or upcoming codec.

In an embodiment the background noise component may be isolated from the input signal as part of the encoding process in the encoding side, thereby providing a division of the input signal frame into a background noise component and an active signal component. Note that in the input frames classified as inactive by the detector 101 a meaningful active signal component may not be present. In such a case the active signal component may comprise a very low-energy—or even zero-energy—signal. The encoded parameters representative of a background noise component of the input signal are provided separately from the encoded parameters representative of an active signal component of the input signal by the encoder 102. The active signal component is encoded by the encoder 102, for example as the input signal from which the background noise component is removed. The background noise component may be also encoded by the encoder 102, or alternatively the encoding of the background noise component may be performed by another encoding/processing block (not shown). Both encoded parameters representative of a background noise component of the input signal and encoded parameters representative of an active signal component of the input signal are provided as separate encoded layers/components of the encoded bit stream for transmission or storage for each input frame. Alternatively, the background noise component may be encoded and provided for transmission or storage only for subset of the input frames. In such a case the background noise component may be encoded and provided for transmission for example according to a pre-determined pattern, for example at pre-determined intervals. Also the detection information, for example VAD information as in the above, is provided together with the encoded component(s) of the input signal in a further embodiment. Thus, also during active input signal, e.g. during active speech/audio, the output frames or packets may comprise one or more encoded components representative of the background noise component and one or more encoded components representative of the active signal component. During inactive input signal the output frames or packets either contain only the encoded component(s) representative of the background noise component, or alternatively the encoded component(s) representative of the background noise component and the encoded component(s) representative of the active signal component. The embodiment facilitates efficient distributed DTX operation, also in combination with embodiment described above, in an intermediate network element 200, for example in a media gateway or in a conference server. Furthermore, using a frame or packet structure like this for transmission also makes it possible to process a background noise component of the input signal separately from an active signal component of the input signal also for various purposes, for example to remove one or more of the encoded components representative of a background noise component of the input signal, to modify one or more of the encoded components representative of a background noise component of the input signal, or to replace one or more of the encoded components representative of a background noise component of the input signal with suitably selected data. Such processing may be performed for example at an intermediate network element 200 or at a receiving apparatus 100′,100″,100′″.

### Extraction

Yet another embodiment of the invention extracts the background noise component, equivalently as in above, in a multi-channel encoding scenario, and use it as the ambience component. In the embodiment the encoding of background noise, non-speech or inactive signal is considered as one or more encoded enhancement layers/components representing the prevailing ambience conditions in the environment the input signal was captured by for example the encoder 102. The network element 200 may decide to forward the said one or more encoded components representative of an ambience component of the input signal to enable natural representation in a receiving terminal device, or it may drop it to for example due to bandwidth constraints. Naturally, the receiving terminal device 100′,100″,100′″ as well as the decoder and audio rendering tools have the possibility to either apply or dismiss the said one or more encoded components representative of an ambience component of the input signal.

### Detection Information

In an embodiment of the invention, the detection information—alternatively referred to as signal activity information—provided together with the encoded signal may comprise a simple signal activity flag having two possible values. As an example, the activity flag bit is set to value “one” when the respective encoded signal represents active signal, and the activity flag bit is set to value “zero” to indicate inactive signal.

In another embodiment, the signal activity information may comprise an activity indicator, which is assigned more than two possible values to enable indicating wider variety of signal activity status values instead of only fully active or fully non-active signal. Any suitable number of bits can used to represent the value range—for example from 0 to 1—to indicate the activity level of the respective input signal for example in such a way that a higher value indicates higher level of signal activity. In a similar manner, in an alternative embodiment the chosen value range with suitable granularity is used to indicate the probability of active signal content in respective input signal, for example in such a way that a higher indicator value indicates a higher activity level. In further embodiments the activity indicator can be used as a reliability indication of the signal activity decision, or as a QoE parameter for signal activity, for example in such a way that a higher indicator value indicates a higher reliability level or a higher QoE level, respectively.

In yet another embodiment the signal activity information comprises multiple indicators. As an example, one indicator may be included to indicate speech/non-speech, whereas another indicator may be used whether a music signal is present or not. Yet another example is an indicator for the presence of an information tone or information tones. In a further embodiment the multiple indicators may provide partially overlapping information, the signal activity information may comprise e.g. a speech indicator and a generic signal activity indicator. The signal activity information comprising multiple indicators may comprise indicators of different type. For example a first subset of indicators may be two-valued flags, a second subset of indicators may use a first number of bits to represent a value in a first value range, and/or a third subset of indicators may use a second number of bits to represent a value in a second value range.

### Network Element

A network element 200 receives a stream of encoded speech/audio frames—or alternatively accesses encoded speech/audio frames stored in a memory, for example as a media file—with the respective detection information. The network element 200 forwards the received frames downlink to the receiving terminal device, to another network element—or to multiple receiving terminal devices in case of a multi-party session. The network element 200 may, for example, be a media processor, transcoder, a server, a part of the server, a part of a system, or the like. The network element 200 may comprise a multipoint control unit (MCU) or the like. The network element 200 controls the forwarding of encoded speech/audio frames in downlink direction and it is able to modify the encoded bit stream it receives in the input frames. In an alternative embodiment the network element 200 comprises an element within the network or with the device itself, such as a processor or coding unit or the like. Using for example a session parameter negotiation mechanisms, such as Session Description Protocol (SDP) or any terminal capability negotiation protocol such as Open Mobile Alliance Device Management), the network element 200 may be aware of the capability of each receiving terminal device 100′,100″,100′″ and/or the requirements of the corresponding access link. Alternatively, the network element 200 may have a priori information on capabilities of one or more receiving terminal devices and/or the requirements of the access links it is serving. Furthermore, the capabilities of receiving terminal devices and/or requirements of the access links may stay unchanged during the whole session, or they may change during the session. In case the received bit stream comprises multiple encoded components, the network element 200 is able to scale the received bit stream by removing or modifying sufficient number of encoded components to meet for example the bit rate, complexity and/or QoE requirements.

In an embodiment of the invention, the modification of the received frames in the network element 200 comprises applying a DTX processing. The network element 200 evaluates the detection information provided together with the respective encoded data, and uses this information to control the processing it is configured to perform, for example DTX processing. The network element 200 may apply a pre-determined rule to select the input frames to be provided for transmission forward without modification, the input frames to be modified before being provided for transmission forward, and the input frames not to be forwarded. Furthermore, in case the network element 200 is serving multiple output streams, a different processing may be carried out for each of the outputs or for each subset of outputs.

In an embodiment, the network element 200 derives an output activity flag based on the detection information received together with the respective encoded data to decide whether the respective frame is to be considered active or inactive output frame. If the network element 200 is serving multiple streams of output frames based on a single stream of input frames, a dedicated output activity flag may be derived for each output or for each subset of outputs, possibly applying different decision logic in deriving the output activity flag for each output or for each subset of outputs. Alternatively, all outputs or a subset of outputs may share an output activity flag.

In an embodiment employing a single activity flag as the detection information, all input frames indicated as active signal are declared as active also in the output. Similarly, inactive input frames are declared as inactive output frames.

In another embodiment the received detection information comprises an activity indicator having several possible values, for example within range from 0 to 1, indicating for example the level of signal activity in the respective frame of input signal, probability of the respective frame representing active signal content, or reliability of the respective signal activity decision, as described above. In this scenario the network element 200 applies suitable selection rule to make the final classification into active and inactive output frames. As an example, input frames having a value of activity indicator above a first threshold are declared as active output frames, while the rest of the input frames are declared as inactive output frames. As another example, input frames having an activity indicator value below a second threshold are declared as inactive output frames, whereas the rest of the input frames are declared as active output frames. The thresholds mentioned above may be fixed or adaptive. As an example, the possible adaptation may be at least partially based on the observed signal characteristics. As another example, the adaptation of a threshold may be at least partially based on the activity indicator values received for one or more previous frames. As a further example, the adaptation may be at least partially based on output activity decision made for one or more previous frames.

In yet another embodiment the received detection information comprises a number of distinct activity indicators. As an example, the detection information comprises a first indicator with two possible values—for example 0 or 1—indicating the speech/non-speech and a second indicator indicating a general signal activity—also with two possible values 0 and 1. In this embodiment the network element 200 may be configured for example to declare only input frames indicated to represent active speech content (based on the first indicator) as active output frames, while all other input frames are declared as inactive output frames. Alternatively, as another example the network element 200 may be configured to declare all input frames indicated to represent active signal content in general (according to the second indicator) as active output frames, while declaring all other input frames as inactive output frames. As a further example, the network element 200 may be configured to declare input frames indicated to represent inactive speech (according to the first indicator) but at the same indicated to represent active signal content in general (according to the second indicator) as active output frames, while all other input frames are declared as inactive output frames. Furthermore, the network element 200 serving multiple output bit streams may for example use the output activity decision based on the first indicator of the input activity information for a first subset of outputs, and use the output activity decision based on the second indicator of the input activity information for a second subset of outputs. Generally, input activity information may comprise any number of distinct activity indicators, and the network element 200 may use any combination or any subset of the indicators to derive the value of the output activity decision for a given output bit stream or for a given set of output bit streams.

In a further embodiment the received detection information comprises a number of distinct activity indicators having values for example in range from 0 to 1. As an example, the detection information comprises a first indicator indicating the speech/non-speech and a second indicator indicating a general signal activity. In this embodiment the network element 200 may be configured for example to declare only input frames for which the first indicator has a value greater than a first threshold TH1 and the second indicator has a value greater than a second threshold TH2 as active output frames, while the rest of the input frames are declared as inactive output frames. As another example, only input frames for which the second indicator has a value less than a third threshold TH3 are declared as inactive output frames, whereas all other input fames are declared as active output frames. In further examples, different thresholds or completely different decision logics may be used for different subsets of output bit streams. Furthermore, the input activity information may comprise any number of distinct activity indicators, the distinct activity indicators may have different value ranges, and the network element 200 may use any combination or any subset of the indicators to derive the value of the output activity decision.

In an embodiment of the invention, all input frames indicated as active output frames by the output activity decision are provided for transmission forward without modification, whereas some of the input frames indicated as inactive output frames are modified before providing for transmission forward and some of the inactive output frames are not forwarded. Alternatively, also some—or all—of the active output frames may be modified before providing them for transmission forward. The decision whether to modify or discard an inactive input frame is made based on the applied DTX scheme. As an example, inactive frames are chosen for modification according to a pre-defined pattern, for example in such a way that every eighth frame within a series of successive inactive frames is chosen for modification, and rest of the frames within the series are not forwarded at all. As another example, the selection of frames for modification process prior to transmission forward within a series of successive inactive frames may be based on the characteristics of the received encoded frames, for example in such a way that only frames that indicate difference exceeding a certain threshold compared to previously selected frame are selected for modification process, while rest of the inactive frames within the series are not forwarded.

The network element 200 may apply some safety margins or hysteresis as part of the applied DTX scheme in a further embodiment of the invention. As an example, such a hangover period may comprise a number of frames in the beginning of a series of inactive frames that are provided for transmission forward without modification e.g. to make sure that active signal is not clipped. The number of frames belonging to the hangover period may be a pre-determined number or the number of frames may be set for example at least partially based on the observed characteristics in one or more previously received frames. As an example, highly fluctuating signal may require a longer hangover period than a more stationary signal. As another example, the number of frames belonging to a hangover period may be set at least partially based on detection information received for one or more previous frames

In an embodiment, the network element 200 receives each input frame as a single encoded component representative of a background noise component and an active signal component of the input signal, together with the respective detection information. Alternatively, the received frames may comprise a number of encoded components—for example a core layer and possibly a number of enhancement layers, as discussed in the context of layered coding approach above—each representing a background noise component and an active signal component of the input signal. The inactive input frames selected for modification before providing them for transmission forward may be processed by encoding them as SID frames. As an example, the SID encoding may be performed in coded domain, comprising extracting a subset of the parameters received as part of the respective input frame and re-packing them into output frame to form a SID frame. An example of suitable parameters are LPC parameters or the like, representative of the spectral content of the input signal, and gain parameters or the like, representative of the energy level of the input signal. In another example the SID encoding comprises determining the parameter values for an output SID frame based on combination of values of respective parameter values in a number of input frames.

In another embodiment, the network element 200 receives input frames as one or more encoded components representative of a background noise component of the input signal, and one or more encoded components representative of an active signal component of the input signal, together with the respective signal activity information. The inactive input frames selected for modification before providing them for transmission forward may be processed by encoding them as SID frames. As an example, the SID encoding may comprise selecting and extracting one or more of the encoded components representative of the background noise component of the input signal, and providing them as the output frame for transmission forward.

In the another embodiment, the network element 200 also has the possibility to modify some—or all—of the input frames declared as active output frames. As an example, the network element 200 may modify an input frame in such a way only a subset of the one or more of the encoded components representative of the background noise component and/or a subset of one or more of the components representative of the active signal component are provided for transmission forward.

In embodiments of the invention, an output frame of the network element 200 may comprise detection information, such as SAD/VAD information discussed above, received in the respective input frame. Alternatively, an output frame of the network element 200 may comprise detection information derived based at least part on the detection information received in respective input frame, such as the output activity flag discussed above. In yet another alternative an output frame of the network element 200 may comprise detection information comprising detection information received in respective input frame and detection information derived based at least part on the detection information received in respective input frame.

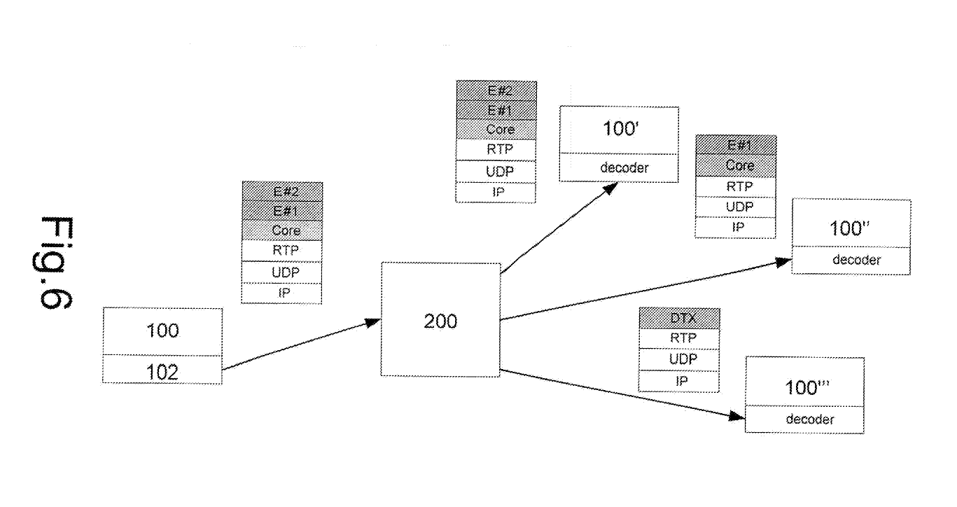

FIG. 6 depicts an example of a multiparty coding session in accordance with an embodiment of the invention. FIG. 6 presents an embodiment of the basic architecture of the session. The apparatus 100 can be for example client #1, the receiving terminal devices 100′,100″ are clients #2 and #3, respectively, and the network element 200 is the MCU. The apparatus 100 transmits speech/audio frames, for example in IP/UDP/RTP packets to receiving terminal devices 100′, 100″ through the network element 200. The transmitted frames, e.g. the RTP payloads of the IP/UDP/RTP packets, carry the encoded layered bit stream comprising an encoded core layer (“Core”) and two enhancement layers (“E#1”, “E#2”) the signal activity information. FIG. 6 presents the snapshot of the frames sent forward from the transmitting apparatus 100 via the network element 200 to the receiving apparatuses 100′,100″. As presented in FIG. 6, the frames forwarded to downlink direction comprise a core layer (core) and possibly a plurality of enhancement layers (E #1, E #2, . . . ). In an embodiment of the invention, the layered bit stream may contain the encoded background noise, non-speech or inactive signal, each encoded layer/component representing the background noise component of the input signal and the active signal component of the input signal.

In FIG. 6, the network element 200, such as the MCU, has forwarded the frame as received to the receiving apparatus 100′, like client #2. Since the receiving apparatus 100″, for example client #3, has a reduced capability due to, for example decoder, access link capabilities or network operator policy, the network element 200 has modified the input frame by removing one of the enhancement layers—E#2—from the input frame to provide the output frame for the receiving apparatus 100″. The bit stream may or may not still contain the signal activity information, and the receiving apparatus may use it for e.g. error concealment purposes. In further embodiments, the network element 200 may modify the received signal activity information before providing it for transmission forward. The receiving apparatus 100′″, for example client #4, may have even more stringent restrictions in downlink direction reception. The network or the receiving apparatus has requested the usage of DTX functionality in downlink. Therefore, the network element 200 extracts the signal activity information for frames it receives, and encodes SID frames based on the signal activity information and encoded data received in the input frames for transmission in downlink according to a DTX scheme, as described above.

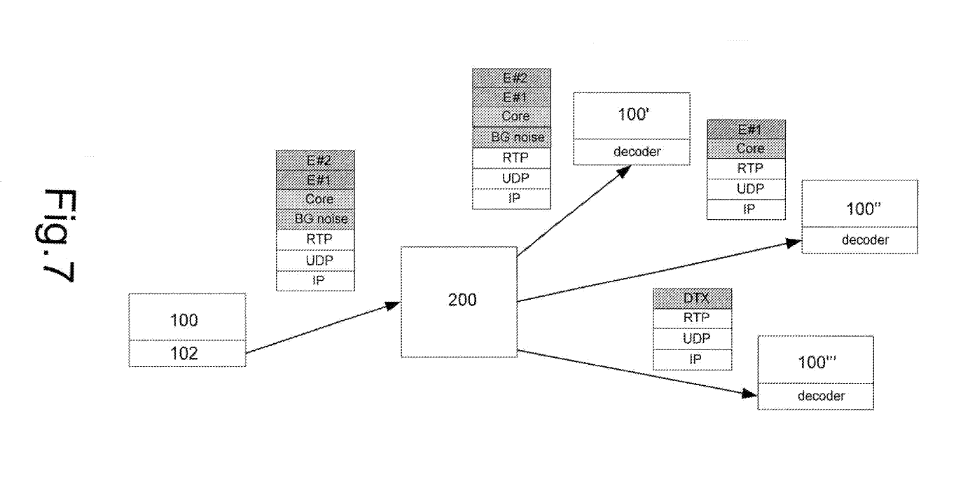

FIG. 7 depicts another example of a multiparty coding session in accordance with an embodiment of the invention. In FIG. 7 the encoded bit stream provided by the apparatus 100, for example client #1, comprises one encoded layer representative of a background noise component of the input signal (“BG noise”) and three layers representative of an active signal component of the input signal (“Core”, “E#1”, “E#2”). As in FIG. 6, the network element 200, such as the MCU, forwards the received frame without modification to the receiving apparatus 100′, like client #2. Due to capability restrictions, the network element 200 modifies the input frame by removing the layer representative of a background noise component of the input signal (“BG noise”) and one of the layers representative of an active signal component of the input signal (“E#2”) to provide an output frame for transmission to the receiving apparatus 100″, for example client #3. Furthermore, the network element 200 applies DTX processing and encodes SID frames for transmission in downlink to the receiving apparatus 100′″. The SID encoding may be based on the signal activity information and encoded data provided in the input frames by providing only the received encoded layer representative of a background noise component of the input signal for transmission as a SID frame, for example as discussed above.

As presented in the examples of FIGS. 6 and 7, the network element 200 is able to forward different bit stream to different receiving terminal devices 100′,100″,100′″. While the receiver 100′ and 100″ (e.g. clients #2 and #3) receive bit stream encoded as active speech/audio ensuring maximum quality with the given bit rate without possible degradation caused by the DTX functionality, the

DTX functionality is still enabled to save capacity in the access link towards the receiving terminal device 100′″, which can for example be client #4.

### Decoding

In an embodiment of the invention, a receiving terminal device comprises a receiver receiving the encoded frames from a transmitting terminal device or from a network element, and a decoder for decoding the received encoded frames.

In an embodiment, the receiving terminal device receives input frames comprising one or more encoded components representative of a background noise component of the input signal, and one or more encoded components representative of an active signal component of the input signal. Furthermore, the input frames may comprise respective detection information, such as VAD/SAD information and/or information based at least part on VAD/SAD information discussed above. The decoder may use a subset of received encoded components for reconstructing the input signal. As an example, the decoder may select the received encoded components to be used for reconstructing the input signal based at least part on the received respective detection information in such a way, that received frames indicated as inactive frames are reconstructed based at least part on one or more of the received encoded components representative of a background noise component of the input signal, whereas received frames indicated as active frames are reconstructed based at least part on one or more of the received encoded components representative of a background noise component of the input signal and one or more of the received encoded components representative of an active signal component of the input signal. As another example, the received frames indicated as active frames may be reconstructed based at least part on one or more of the received encoded components representative of an active signal component of the input signal. In yet another example the decoder may reconstruct all received frames based at least part on one or more of the received encoded components representative of an active signal component of the input signal.

In an embodiment of the invention, the receiving terminal device may receive some input frames comprising one or more encoded components representative of a background component of the input signal, while some input frames may be received comprising one or more encoded components representative of an active signal component of the input signal. Furthermore, the input frames may comprise respective detection information

In various embodiments, the receiving terminal device may use the received detection information for example by providing the detection information to error concealment unit—within the decoder or in a processing unit separate from the decoder—to be used in the error concealment process for subsequent or preceding frames. Another example of the usage of the received detection information in the receiving terminal device is to provide the detection information for the (jitter) buffering unit typically used in a terminal device receiving data over a PS connection. Furthermore, the receiving terminal device may use the received detection information for various other purposes to enhance decoding process and related processes—such as error concealment and buffering mentioned above, as well as for e.g. signal characteristics estimation purposes or quality monitoring purposes.

### Ramifications and Scope

Although the description above contains many specifics, these are merely provided to illustrate the invention and should not be construed as limitations of the invention's scope. It should be also noted that the many specifics can be combined in various ways in a single or multiple embodiments. Thus it will be apparent to those skilled in the art that various modifications and variations can be made in the apparatuses and processes of the present invention without departing from the spirit or scope of the invention.

1. An apparatus, comprising:
a detector configured to extract detection information indicating whether an input frame is active input signal or non-active input signal, and
an encoder configured to, in response to detection information indicating non-active input signal, encode the input frame as one or more encoded components representative of a background noise component of said input frame and as one or more encoded components representative of an active signal component of said input frame wherein an output frame of the apparatus comprises the one or more encoded components representative of the background noise component of said input frame, the one or more encoded components representative of the active signal component of said input frame, and said detection information.

2. (canceled)

3. An apparatus according to claim 1, wherein the encoder is further configured to split the input frame into the background noise component and the active signal component.

4. (canceled)

5. An apparatus according to claim 1, wherein said detection information comprises one or more activity indicators.

6. (canceled)

7. An apparatus according to claim 5, wherein said one or more activity indicators comprise one or more indicators indicating a probability of input frame being active input signal.

8. (canceled)

9. An apparatus, comprising:
a receiver configured to receive an encoded input frame comprising detection information, wherein the detection information indicates whether the input frame represents active input signal or non-active input signal,
a detector configured to detect a network or a receiving terminal device characteristics,
an encoder configured to provide an output frame based at least part on said encoded input frame and said network or receiving terminal device characteristics so that, depending on the network or receiving terminal device characteristics and on the detection information, said output frame is encoded to meet the network or receiving terminal device characteristics.

10. (canceled)

11. An apparatus according to claim 9, wherein the encoder is further configured to classify said output frame as active or inactive based at least part on the detection information.

12. (canceled)

13. An apparatus according to claim 11, wherein the encoder is further configured to provide said output frame by providing a subset of said encoded input frame as the output frame in case the output frame is classified as inactive.

14. An apparatus according to claim 13, wherein said encoded input frame comprises one or more encoded components representative of a background noise component of a signal and one or more encoded components representative of an active signal component of said signal, and said providing a subset of said encoded input frame as the output frame comprises providing one or more of the encoded components representative of a background noise component of said signal as the output frame.

15. An apparatus according to claim 9, wherein the detection information comprises one or more activity indicators.

16. (canceled)

17. An apparatus according to claim 15, wherein said one or more activity indicators comprise one or more indicators indicating a probability of input frame being active input signal.

18. (canceled)

19. A method, comprising:
extracting detection information indicating whether an input frame is active input signal or non-active input signal,
in response to detection information indicating non-active input signal, encoding the input frame as one or more encoded components representative of a background noise component of said input frame and as one or more encoded components representative of an active signal component of said input frame, and
providing an output signal frame comprising the one or more encoded components representative of the background noise component of said input frame, the one or more encoded components representative of the active signal component of said input frame, and said detection information.

20. (canceled)

21. A method according to claim 19, further comprising splitting the input frame into a background noise component and an active signal component.

22. (canceled)

23. A method according to claim 19, wherein said detection information comprises one or more activity indicators.

24. (canceled)

25. A method according to claim 23, wherein said one or more activity indicators comprise one or more indicators indicating a probability of input frame being active input signal.

26. (canceled)

27. A method, comprising:
receiving an encoded input frame comprising detection information, wherein the detection information indicates whether the input frame represents active input signal or non-active input signal,
detecting a network or a receiving terminal device characteristics, and
providing an output frame based at least part on said encoded input frame and said network or receiving terminal device characteristics so that, depending on the network or receiving terminal device characteristics and on the detection information, said output frame is encoded to meet the network or receiving terminal device characteristics.

28. (canceled)

29. A method according to claim 27, further comprising classifying said output frame as active or inactive at least partially based on said detection information.

30. (canceled)

31. A method according to claim 29, wherein said providing comprises providing a subset of said encoded input frame as the output frame in case the output frame is classified as inactive.

32. A method according to claim 31, wherein said encoded input frame comprises one or more encoded components representative of a background noise component of a signal and one or more encoded components representative of an active signal component of said signal, and said providing a subset of said encoded input frame as the output frame comprises providing one or more of the encoded components representative of a background noise component of said signal as the output frame.

33. A method according to claim 27, wherein said detection information comprises one or more activity indicators.

34. (canceled)

35. A method according to claim 33, wherein said one or more activity indicators comprise one or more indicators indicating a probability of input frame being active input signal.

36. (canceled)

37. A software program, comprising code configured to perform the method of claim 27 when the program is run on a processor.

38. (canceled)

39. (canceled)
